(19) United States
(12) Patent Application Publication
(10) Pub. No.: US 2007/0290478 A1
(43) Pub. Date: Dec. 20, 2007

(54) Bicycle

(76) Inventor: Chien-Sheng Ting, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/452,916

(22) Filed: Jun. 15, 2006

(51) Int. Cl. B62M 1/02

(52) U.S. Cl. 280/260

(57) ABSTRACT

A bicycle having features of double acceleration, comprising a steel frame and an accelerator; on the steel frame is mounted a pedal chain wheel and a rear chain wheel, and the accelerator further comprises a smaller chain wheel, a larger chain wheel and a flywheel; the pedal chain wheel is connected to a smaller chain wheel with a front chain; in the same way, the larger chain wheel is connected to the rear chain wheel with a rear chain, so as to transmit the rotary motion of the pedal chain wheel to the rear chain wheel for achieving higher speeds with improved stability.

### FIELD OF THE INVENTION

The present invention is related generally to a bicycle and, more particularly, to a bicycle having features of double acceleration.

### BACKGROUND OF THE INVENTION

The mechanism of a conventional bicycle comprises a headset, a pedal shaft, a pedal, a pedal chain wheel, a rear chain wheel, saddle, front and back wheels, which are all mounted on a steel frame, with the pedal chain connected to the rear chain wheel through a chain. When a cyclist is pedaling, the pedal is provided to be stepped on to drive the pedal chain wheel, which in turn drives the rear chain wheel, resulting in the rear chain wheel driving the rear wheel so as to drive the bicycle forwards. For example, in the case of a bicycle in which the number of the gear teeth of the pedal chain wheel is double that of the rear chain wheel, when the pedal chain wheel rotates one turn, the rear chain wheel rotates twice. In theory, the greater the ratio of the gear teeth of a pedal chain wheel to that of a rear chain wheel is, the greater is the number of turns of the rear wheel driven by one turn from the pedal chain wheel, and also the faster the speed of the bicycle, therefore a different kinds of variable speed bicycles have been developed. Most existing variable speed bicycles have multiple chain wheels in different sizes and numbers of gear teeth mounted at the wheel shafts of either the pedal chain or the rear chain, or both of them, connecting the pedal chain wheel and the chain of the rear chain wheel with a simple lever by shifting and matching different chains so as to adjust the speed and properties of a bicycle, as a result, the limitation of speed of the bicycle is controlled by the size of the chains.

Therefore, it is still desirable for increasing the speed of a bicycle.

### SUMMARY OF THE INVENTION

One object of the present invention is to provide a device to increase the speed of a bicycle.

A bicycle according to the present invention comprises a steel frame and an accelerator. On the steel frame are mounted a pedal chain wheel and a rear chain wheel, and the accelerator comprises a smaller chain wheel, a larger chain wheel and a flywheel all mounted on a shaft such that the smaller chain wheel, the larger chain wheel and the flywheel have the same rotating shaft with the same rotating speed. The smaller chain wheel is connected to the pedal chain wheel with a first chain and in the same way, the larger chain wheel is connected to the rear chain wheel with a second chain. Thus, the speed of the bicycle can be increased by double the standard acceleration.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a perspective view of the mechanism of a first preferred embodiment according to the present invention;

FIG. 2 is a mechanical view of the accelerator shown in FIG. 1;

FIG. 3 is an enlarged view of a part shown in FIG. 1;

FIG. 4 is a perspective view of the mechanism of a second preferred embodiment according to the present invention;

FIG. 5 is a perspective view of the mechanism of a third preferred embodiment according to the present invention;

FIG. 6 is an undersurface view of the third preferred embodiment shown in FIG. 5;

FIG. 7 is a perspective view of the mechanism of a fourth preferred embodiment according to the present invention; and

FIG. 8 is an undersurface view of FIG. 7.

### DETAIL DESCRIPTION OF THE INVENTION

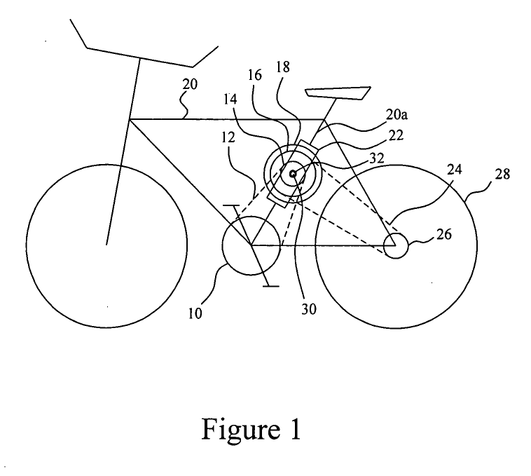

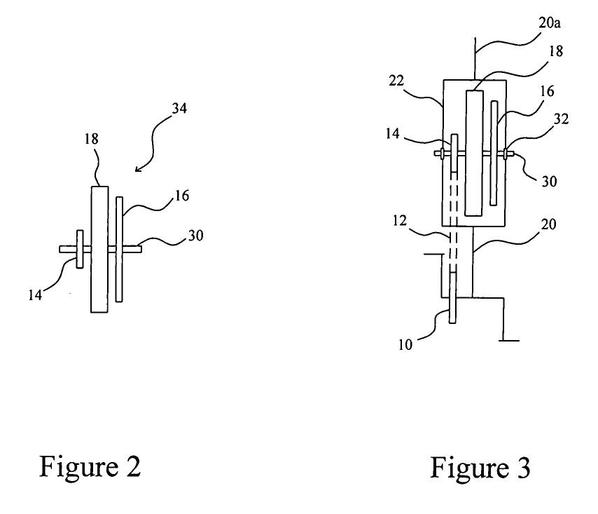

FIG. 1 is a schematic view of the mechanical structure of a first preferred embodiment according to the present invention, in which a bicycle comprises a lozenge-shaped steel frame 20 on which mounted a headset, a front wheel, a saddle, a pedal chain wheel 10, a rear chain wheel 26, a rear wheel 28, and an accelerator frame 22 having an accelerator 34 thereof. The detailed structure is as shown in FIGS. 2 and 3. The accelerator frame 22 is mounted on the central seat tube 20a, and the accelerator 34 comprises a rotating shaft 30 which passes through the hub of the wheels, namely, a smaller chain wheel 14, a flywheel 18 and a larger chain wheel 16, and a bearing bracket 32 is on the accelerator frame 22, thus, the smaller chain wheel 14, the flywheel 18 and the larger wheel 16 have the same speed with the same axis and the smaller chain wheel 14 is connected to the pedal chain wheel 10 with a front chain 12, while the larger chain wheel 16 is connected to the rear chain wheel 26 with a rear chain 24. For example, in the case that the number of gear teeth of the chain wheel 10 is double to the gear teeth of the smaller chain wheel 14, in other words, the ratio of the numbers of the two gear teeth is 2, and also the number of gear teeth of the larger chain wheel is double to the gear teeth of the smaller chain wheel, namely, the ratio is 2 as well, then, when the pedal chain 10 rotating one turn, the smaller chain wheel 14 rotates two turns so that the rotating speed of the smaller chain wheel 14 is twice the rotating speed of the pedal chain 10; the smaller chain wheel 14 and the larger chain wheel 16 have the same rotating speed, but the number of gear teeth of the larger chain wheel 16 is two times the teeth of the smaller chain wheel 14. Therefore, in this way, the speed of the rear chain wheel 26 becomes 8 times that of the speed of the pedal chain 10, so that the speed of the rear wheel can be increased greatly. When the accelerator 34 is rotating, the inertial momentum from the flywheel 18, which is right in the middle of the rotating shaft 30, stabilizes the rotating speed of the accelerator 34 and stores the kinetic energy as an accessorial momentum of the bicycle so that can save the energy of the cyclist.

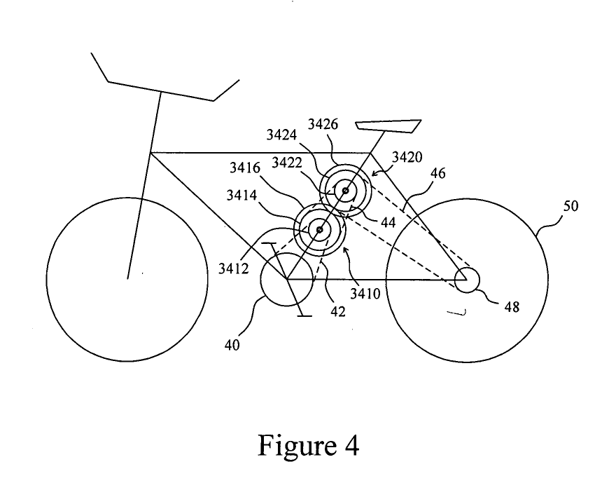

FIG. 4 is a schematic view of the mechanical structure of a second preferred embodiment according to the present invention, in which the mechanism of both a first accelerator 3410 and a second 3420 are the same as the accelerator 34 shown in FIG. 2. When a pedal chain wheel 40 is rotating, a first chain 42 rotates a first smaller chain wheel 3412 of the first accelerator 3410, in turn, making both a first larger chain wheel 3414 and a first flywheel 3416 rotate, and the first larger chain wheel 3414 drives a second smaller chain wheel 3422 of the second accelerator 3420 with a middle chain 44 so as to make both the second larger chain wheel 3424 of the second accelerator 3420 and a second flywheel 3426 rotating in turn, the second larger chain wheel 3424 is connected to a second chain wheel 48 with a rear chain 46, and drive a rear wheel 50. Through the acceleration system, the rotating speed of the rear wheel 50 is increased substantially.

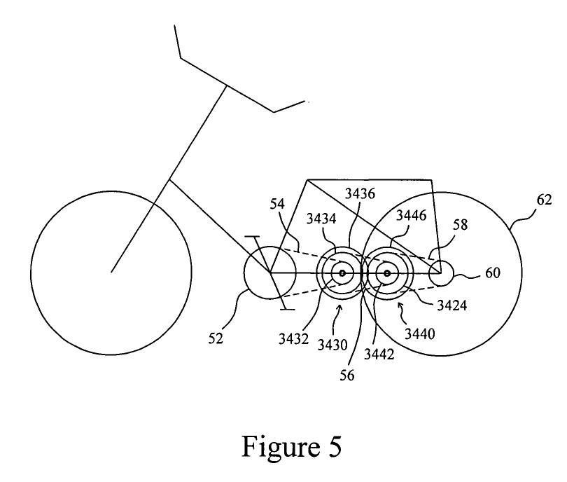

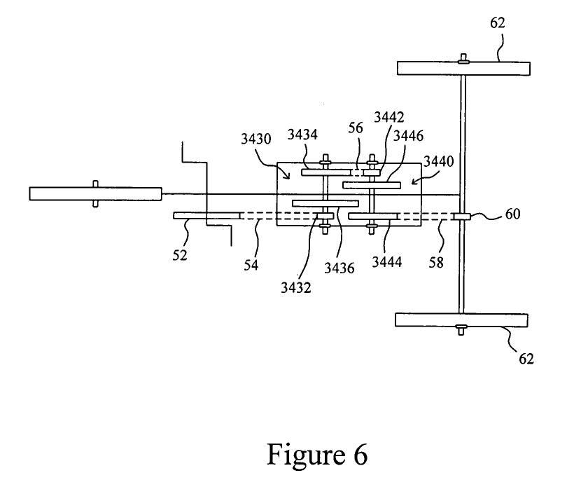

FIG. 5 illustrates a third preferred embodiment of the present invention, in which two accelerators 3430 and 3440 are applied to a tricycle, and FIG. 6 shows its undersurface view. The mechanism of the first accelerator 3430 and the second accelerator 3440 is the same as the accelerator shown in FIG. 2, and the way of acceleration is the same as the preferred embodiment shown in FIG. 4, but in order to reduce the space occupied by the accelerators 3430 and 3440, in this preferred embodiment, a first larger chain wheel 3434 of the first accelerator 3430 with a first flywheel 3436 and a second larger chain wheel 3444 of the second accelerator 3440 with a second flywheel 3446 are allocated by an interleaving arrangement. When a pedal chain wheel 52 is rotating, it drives the first smaller chain wheel 3432 connected by a first chain 54 between them, meanwhile, it also drives the first flywheel 3436 and the first larger chain wheel 3434 which rotates a second smaller chain wheel 3442 connected with a middle chain 56 between them, together with a second flywheel 3446 and a second larger chain wheel 3444 which drives a second chain wheel 60 connected by a second chain 58 making a rear wheel 62 rolling so as to increase the rotating speed of the rear wheel 62.

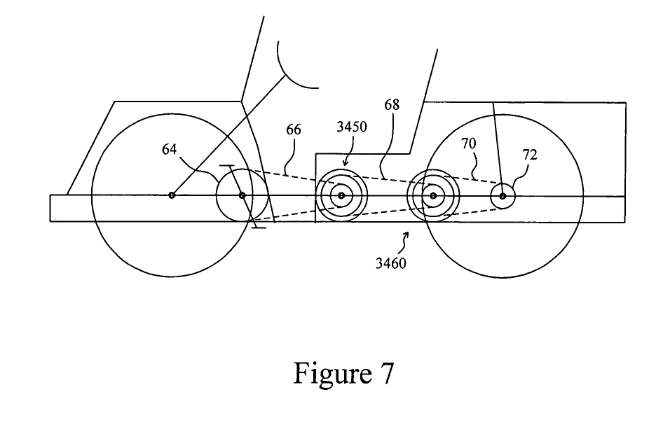

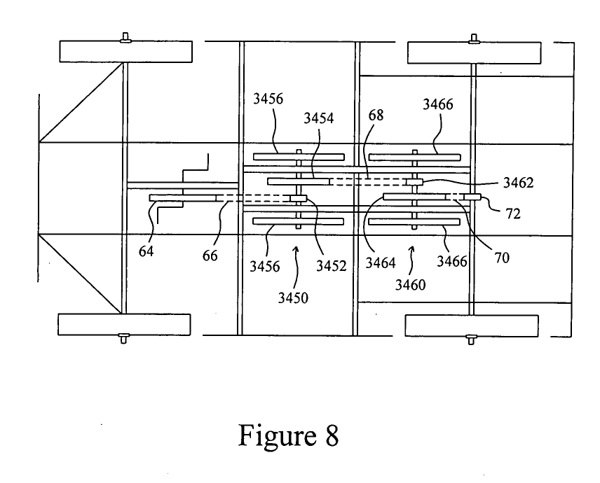

FIG. 7 illustrates a fourth embodiment of the present invention, in which a first accelerator 3450 and a second accelerator 3460 are applied to a four-wheel pedal cart and FIG. 8 shows its undersurface view. In this preferred embodiment, both the first accelerator 3450 and the second accelerator 3460 have two flywheels respectively for the purpose of increasing stability and saving the energy of pedaling. When a pedal chain wheel 64 rotating, it drives a first smaller chain wheel of the first accelerator 3450 connected by a first chain 66, meanwhile, it also drives a first lager chain wheel 3454 and its two first flywheels 3456, and the first larger chain wheel 3454 drives a second smaller chain wheel 3462 turning connected by a middle chain 68, in turn, it also drives a second larger chain wheel 3464 and its two secondary flywheels 3466, and the second larger chain wheel drives a second chain wheel 72 connected by a second chain 70 so as to drive the rear wheels of the cart.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A bicycle comprising:
a steel frame on which is mounted a pedal chain wheel and a rear chain wheel; and
an accelerator mounted on the steel frame, the accelerator including a larger chain wheel, a smaller chain wheel and a flywheel all passing through with a rotating shaft, the smaller chain wheel connected to the pedal chain wheel with a first chain, the larger chain wheel connected to the rear chain wheel with a second chain.

2. The bicycle of claim 1, wherein the flywheel is between the larger chain wheel and the smaller chain wheel.

3. A bicycle comprising:
a steel frame on which is mounted a pedal chain wheel and a rear chain wheel;
a first accelerator mounted on the steel frame, the first accelerator including a first lager chain wheel, a first smaller chain wheel and a first flywheel all passing through with a first rotating shaft, the first smaller chain wheel connected to the pedal chain wheel with a first chain wheel; and
a second accelerator mounted on the steel frame, the second accelerator including a second larger chain wheel, a second smaller chain wheel and a second flywheel all passing through with a second rotating shaft, the second smaller chain wheel connected to the first larger chain wheel of the first accelerator with a second chain, the second larger chain wheel connected to the rear chain wheel with a third chain.
